(19) United States
(12) Patent Application Publication
(10) Pub. No.: US 2023/0061453 A1
(43) Pub. Date: Mar. 2, 2023

(54) DRIVING HANDOVER SYSTEM, DRIVING HANDOVER METHOD

(71) Applicant: TOYOTA JIDOSHA KABUSHIKI KAISHA, Toyota-shi (JP)

(72) Inventors: Hideki FUKUDOME, Toyota-shi (JP); Kosuke AKATSUKA, Mishima-shi (JP); Myu UEHARA, Nisshin-shi (JP); Tsukasa KITO, Aisai-shi (JP); Satoshi OMI, Ebina-shi (JP); Yuki NISHIKAWA, Susono-shi (JP)

(73) Assignee: TOYOTA JIDOSHA KABUSHIKI KAISHA, Toyota-shi (JP)

(21) Appl. No.: 17/810,408

(22) Filed: Jul. 1, 2022

(30) Foreign Application Priority Data
Aug. 25, 2021 (JP) 2021-137244

(51) Int. Cl. B60W 60/00; H04W 4/48

(52) U.S. Cl. CPC B60W 60/0061; B60W 60/0059; B60W 60/0053; H04W 4/48

(57) ABSTRACT

A driving handover system according to the present disclosure is configured to execute a detection process of detecting an obstructive article that causes an obstruction of handover to manual driving when the obstructive article is present in a vehicle, and a determination process of determining whether the handover to the manual driving is allowed or disallowed upon receipt of a request for the handover to the manual driving. The driving handover system is configured to, in the determination process, disallow the handover to the manual driving when the obstructive article is detected in the detection process.

### CROSS-REFERENCE TO RELATED APPLICATION

This application claims priority to Japanese Patent Application No. 2021-137244 filed on Aug. 25, 2021, incorporated herein by reference in its entirety.

### BACKGROUND

### 1. Technical Field

The present disclosure relates to a driving handover system that manages handover from remote driving or autonomous driving to manual driving of a vehicle, and a driving handover method.

### 2. Description of Related Art

In a remote driving technique and an autonomous driving technique of a vehicle, there may be a case where the system is configured so as to allow handover of remote driving or autonomous driving to manual driving when a driver who is on board the vehicle performs a predetermined operation for the purpose of improving convenience and as an emergency measure. In such a case, in the related art, a technique for performing appropriate handover to manual driving has been disclosed. For example, Japanese Unexamined Patent Application Publication No. 2018-180689 (JP 2018-180689 A) discloses a driving change control system that determines whether to allow or disallow handover (switching) from autonomous driving to manual driving based on a degree of arousal of the driver and an amount of operation guide.

### SUMMARY

The remote driving technique and the autonomous driving technique are expected to be utilized without requiring the driver to board the vehicle. For example, there is a case where a child who is not capable of driving is picked up or dropped off by remote driving or autonomous driving while only the child is carried by the vehicle. In such a case, when a person who is not capable of driving mistakenly or mischievously performs a predetermined operation (for handover to manual driving), the safety of the vehicle may be threatened. The technique disclosed in JP 2018-180689 A assumes that the person who performs a predetermined operation is a driver.

The present disclosure has been made in view of the above issue, and an object of the present disclosure is to disclose a driving handover system and a driving handover method capable of avoiding inappropriate handover to manual operation.

A first disclosure relates to a driving handover system that manages handover from remote driving or autonomous driving to manual driving of a vehicle. The driving handover system according to the first disclosure includes: at least one memory in which a program is stored; and at least one processor coupled with the at least one memory. Then, through execution of the program, the at least one processor is configured to execute a detection process of detecting an obstructive article that causes an obstruction of the handover to the manual driving when the obstructive article is present in the vehicle, and a determination process of determining whether the handover to the manual driving is allowed or disallowed upon receipt of a request for the handover to the manual driving. The at least one processor is configured to, in the determination process, disallow the handover to the manual driving when the obstructive article is detected in the detection process.

A second disclosure relates to the driving handover system further having the following characteristics with respect to the driving handover system according to the first disclosure. The obstructive article is a specific mobile terminal that is communicable via a communication line, and the at least one processor detects, in the detection process, the obstructive article through communication with the mobile terminal in the vehicle.

A third disclosure relates to the driving handover system further having the following characteristics with respect to the driving handover system according to the first disclosure or the second disclosure.

The at least one processor is configured to, in the detection process, detect a guarantee article that guarantees the handover to the manual driving when the guarantee article is present in the vehicle, and in the determination process, not to disallow the handover to the manual driving when the guarantee article is detected even in a case where the obstructive article is detected in the detection process.

A fourth disclosure relates to a driving handover method for managing handover from remote driving or autonomous driving to manual driving of a vehicle. The driving handover method according to the fourth disclosure includes: a detection process of detecting an obstructive article that causes an obstruction of the handover to the manual driving when the obstructive article is present in the vehicle; and a determination process of determining whether the handover to the manual driving is allowed or disallowed upon receipt of a request for the handover to the manual driving. The determination process includes disallowing the handover to the manual driving when the obstructive article is detected in the detection process.

A fifth disclosure relates to the driving handover method further having the following characteristics with respect to the driving handover method according to the fourth disclosure. The obstructive article is a specific mobile terminal that is communicable via a communication line, and the detection process includes detecting the obstructive article through communication with the mobile terminal in the vehicle.

A sixth disclosure relates to the driving handover method further having the following characteristics with respect to the driving handover method according to the fourth disclosure or the fifth disclosure. The detection process includes detecting a guarantee article that guarantees the handover to the manual driving when the guarantee article is present in the vehicle, and the determination process includes not disallowing the handover to the manual driving when the guarantee article is detected even in a case where the obstructive article is detected in the detection process.

With the driving handover system and the driving handover method according to the present disclosure, detection of the obstructive article makes it possible to avoid inappropriate handover to manual driving, such as when a person who is not capable of driving performs a predetermined operation. Further, when the driver is on board the vehicle, etc., detection of the guarantee article makes it possible to suppress that handover to manual driving is unnecessarily disallowed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for illustrating the outline of functions realized by a driving handover system according to the present embodiment;

FIG. 2 is a conceptual diagram for illustrating the outline of functions realized by the driving handover system according to the present embodiment;

FIG. 3 is a block diagram for illustrating a schematic configuration of the driving handover system according to a first embodiment;

FIG. 4 is a block diagram for illustrating a schematic configuration of the driving handover system according to a second embodiment; and

FIG. 5 is a flowchart showing a driving handover method realized by the driving handover system according to the present embodiment.

### DETAILED DESCRIPTION OF EMBODIMENTS

Hereinafter, an embodiment of the present disclosure will be described with reference to the drawings. However, when the number, quantity, amount, range, etc. of each element are referred to in the embodiments shown below, the idea of the present disclosure is not limited to the numbers mentioned herein except when explicitly stated or when clearly specified by the number in principle. In addition, the configurations and the like described in the embodiments shown below are not necessarily essential to the idea of the present disclosure, except when explicitly stated or when clearly specified in principle. In each figure, the same or corresponding parts are designated by the same reference signs, and duplicated description thereof will be appropriately simplified or omitted.

### 1. Outline

A driving handover system according to the present embodiment manages handover from remote driving or autonomous driving to manual driving of a vehicle. Hereinafter, the outline of functions realized by the driving handover system according to the present embodiment will be described.

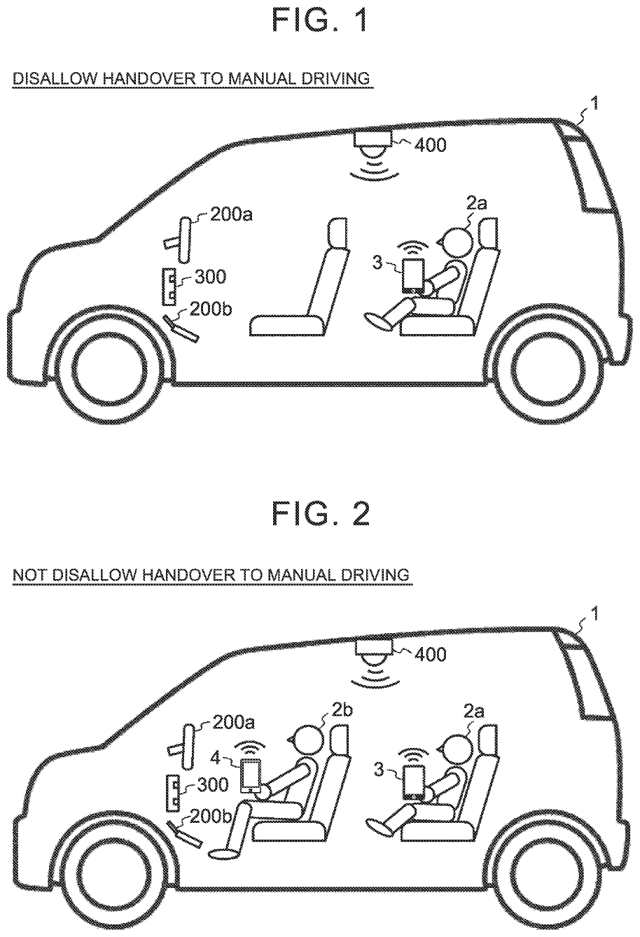

FIGS. 1 and 2 are conceptual diagrams for illustrating the outline of the functions realized by the driving handover system according to the present embodiment. FIG. 1 shows a condition of a vehicle 1 in the case where handover to manual driving is disallowed by the driving handover system according to the present embodiment. Here, the vehicle 1 is a remote driving vehicle or an autonomous driving vehicle that can be driven by remote driving or autonomous driving.

The vehicle 1 is configured to be able to request handover from remote driving or autonomous driving to manual driving when a predetermined operation is performed. The predetermined operation is, for example, an input of an operation amount equal to or more than a predetermined value to a driving operation device 200 (steering wheel 200a, pedal 200b, etc.), selective operation with a human-machine interface (HMI) device 300 (switch, touch panel, etc.), and the like.

In FIG. 1, a child 2a who is not capable of driving is on board the vehicle 1. For example, FIG. 1 shows a case where the child 2a is picked up and dropped off using the vehicle 1. At this time, when a request for handover to manual driving is made as the child 2a performs the predetermined operation, it is appropriate to disallow handover to manual driving.

Therefore, in the driving handover system according to the present embodiment, a specific article related to the child 2a is set as an obstructive article that causes obstruction of handover to manual driving when the obstructive article is present in the vehicle 1, and the obstructive article in the vehicle 1 is detected. Then, when the obstructive article is detected, handover to manual driving is disallowed.

In FIG. 1, the obstructive article is a specific mobile terminal 3 that is communicable via a communication line (typically wireless). The specific mobile terminal 3 is, for example, a smartphone in which the child 2a is registered as a user. In FIG. 1, a terminal detection device 400 detects the obstructive article in the vehicle 1 through communication with the mobile terminal 3 in the vehicle 1.

With the driving handover system configured as described above, it is possible to avoid inappropriate handover to manual driving by detecting the obstructive article when only the child 2a who is not capable of driving is on board the vehicle 1.

On the other hand, when the driver is on board the vehicle 1, it is desirable not to disallow handover to manual driving. FIG. 2 shows a condition of the vehicle 1 in the case where handover to manual driving is not disallowed by the driving handover system according to the present embodiment. In FIG. 2, as compared with FIG. 1, a driver 2b is on board the vehicle 1. The driver 2b is, for example, a parent of the child 2a.

In the driving handover system according to the present embodiment, a specific article related to the driver 2b is set as a guarantee article that guarantees handover to manual driving when the guarantee article is present in the vehicle 1, and the guarantee article in the vehicle 1 is detected. When the guarantee article is further detected even though the obstructive article is detected, handover to manual driving is not disallowed.

In FIG. 2, similar to the obstructive article, the guarantee article is a specific mobile terminal 4 that is communicable via the communication line. The specific mobile terminal 4 is, for example, a smartphone in which the driver 2b is registered as a user. However, the mobile terminal 3 and the mobile terminal 4 can be distinguished from each other in communication. For example, the mobile terminal 3 and the mobile terminal 4 are each assigned with unique identification (ID) information, and the terminal detection device 400 is configured to acquire the ID information through communication.

With the driving handover system configured as described above, it is possible to suppress that handover to manual driving is unnecessarily disallowed by detecting the guarantee article when the driver 2b is also on board the vehicle 1, etc.

### 2. Configuration

Hereinafter, a schematic configuration of the driving handover system according to the present embodiment will be described. Here, a first embodiment is a case where the vehicle 1 performs remote driving, and a second embodiment is a case where the vehicle 1 performs autonomous driving.

### 2-1. First Embodiment

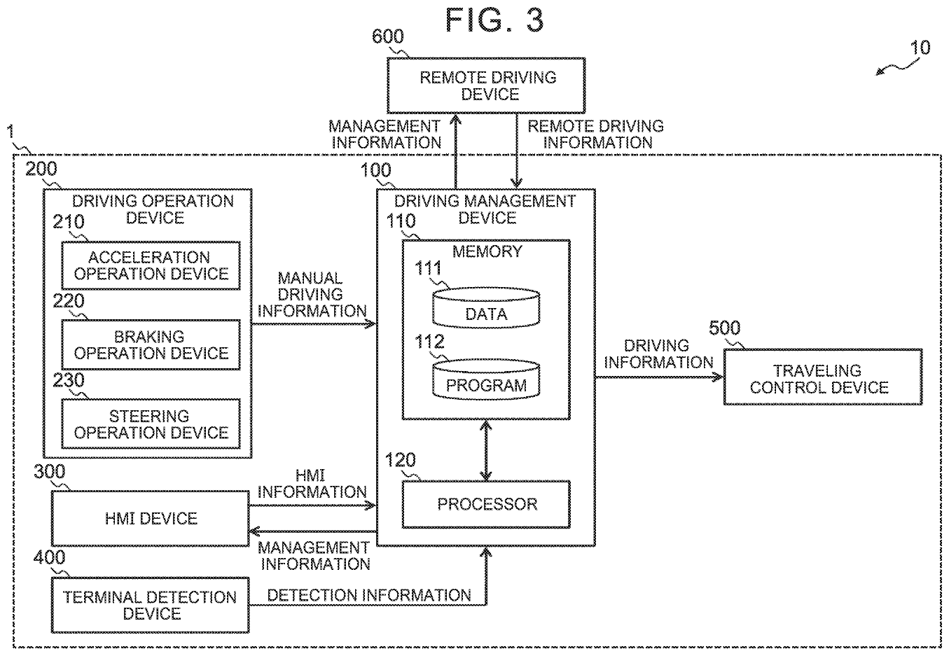

FIG. 3 is a block diagram for illustrating a schematic configuration of the driving handover system 10 according to the first embodiment.

The driving handover system 10 according to the first embodiment includes a driving management device 100, the driving operation device 200, the HMI device 300, the terminal detection device 400, a traveling control device 500, and a remote driving device 600. In the following description, it is assumed that the obstructive article and the guarantee article are specific mobile terminals.

The driving operation device 200 is provided in the vehicle 1 and indicates a device that receives a driving operation related to manual driving of the vehicle 1. The driving operation device 200 includes an acceleration operation device 210, a braking operation device 220, and a steering operation device 230. Information on the driving operation (manual driving information) received by the driving operation device 200 is transmitted to the driving management device 100. The manual driving information includes, for example, an operation amount of the driving operation.

The acceleration operation device 210 is the driving operation device 200 for accelerating the vehicle 1. The acceleration operation device 210 is typically an accelerator pedal. In this case, for example, information on an accelerator operation amount is transmitted to the driving management device 100 as the manual driving information.

The braking operation device 220 is the driving operation device 200 for braking the vehicle 1. The braking operation device 220 is typically a brake pedal. In this case, for example, information on a depression amount of the brake pedal is transmitted to the driving management device 100 as the manual driving information.

The steering operation device 230 is the driving operation device 200 for steering the vehicle 1. The steering operation device 230 is typically a steering wheel. In this case, for example, information on a steering angle of the steering wheel is transmitted to the driving management device 100 as the manual driving information.

The HMI device 300 indicates a device having an HMI function. The HMI device 300 outputs various HMI information (turning on and off of the control function, adjustment of control amount, etc.) and notifies various types of processing information (display, sound, etc.) by performing specific operations. The HMI information output by the HMI device 300 is transmitted to the driving management device 100. Further, the processing information acquired by the HMI device 300 includes management information acquired from the driving management device 100. The management information will be described later.

The HMI device 300 is, for example, a switch, a display, an automobile meter, or a combination thereof. In particular, the HMI device 300 may include a device for performing handover from remote driving to manual driving. This is, for example, a switch for requesting handover from remote driving to manual driving by being pressed. In this case, the HMI information includes information on the request for handover from remote driving to manual driving.

The terminal detection device 400 is a device that detects a mobile terminal present in the vehicle 1 through communication. The terminal detection device 400 outputs information (detection information) on the mobile terminal that is detected. The detection information output by the terminal detection device 400 is transmitted to the driving management device 100.

The terminal detection device 400 is, for example, a device that functions as an access point within the range of the vehicle 1. In this case, the mobile terminal connected to the terminal detection device 400 that is the access point is regarded as the detected mobile terminal, and the detection information is output.

Here, the mobile terminal is, for example, a smartphone or a wearable terminal that is communicable via a communication line. However, the driving handover system 10 according to the present embodiment may be configured such that a mobile terminal on which a predetermined application is installed or a mobile terminal that has performed a predetermined connection procedure is a mobile terminal to be detected. Alternatively, the terminal detection device 400 may be a device that communicates in accordance with a specific communication standard, and the mobile terminal may be a dedicated terminal configured to be communicable with the terminal detection device 400.

The detection information includes information based on which whether the mobile terminal detected by the terminal detection device 400 is the obstructive article or the guarantee article can be identified. This is, for example, unique ID information assigned to each mobile terminal. However, the terminal detection device 400 may be configured to detect only the mobile terminal that is the obstructive article or the guarantee article. In this case, the detection information may include information on whether each of the obstructive article and the guarantee article is detected.

For example, the terminal detection device 400 is configured to store the ID information of the obstructive article or the guarantee article in advance and determine whether the mobile terminal connected to the terminal detection device 400 is the obstructive article or the guarantee article. In this case, at least the terminal detection device 400 includes a memory that stores the ID information and a processor that executes a process of determining whether the mobile terminal is the obstructive article or the guarantee article.

Alternatively, the terminal detection device 400 is configured to be able to acquire the position information of each of the vehicle 1, the obstructive article, and the guarantee article, and configured to determine that the obstructive article or the guarantee article is present in the vehicle 1 when the position of the vehicle 1 and the position of the obstructive article or the guarantee article are equivalent. This can be realized by adopting the configuration in which, for example, the terminal detection device 400 provided in the vehicle 1 functions as a global positioning system (GPS) receiver and can acquire the position information of the obstructive article or the guarantee article via the Internet.

The remote driving device 600 is a device that provides information related to driving (traveling video, driving environment, etc.) to a remote driving operator and receives a driving operation related to remote driving by the operator. The remote driving device 600 is configured to be able to mutually exchange information with the vehicle 1. For example, the vehicle 1 and the remote driving device 600 each include a communication device that is communicable via a communication network (typically, the Internet), and exchange information with each other through communication.

Information on the driving operation (manual driving information) received by the remote driving device 600 is transmitted to the driving management device 100. The remote driving information includes, for example, an operation amount of the driving operation. Further, the remote driving device 600 acquires the management information from the driving management device 100.

The driving management device 100 is a device that determines whether manual driving by the driving operation device 200 and remote driving by the remote driving device 600 are allowed, and manages driving of the vehicle 1. In particular, in the driving management device 100, a process of managing handover from remote driving to manual driving is executed. The driving management device 100 is configured to be able to mutually exchange information with the driving operation device 200, the HMI device 300, the terminal detection device 400, and the remote driving device 600.

The driving management device 100 transmits, as the management information, information on whether manual driving by the driving operation device 200 and remote driving by the remote driving device 600 are allowed to the HMI device 300 and the remote driving device 600. The HMI device 300 and the remote driving device 600 notify an occupant of the vehicle 1 and the remote driving operator of whether manual driving and remote driving are allowed based on the management information.

When the vehicle 1 is driven by manual driving by the driving operation device 200, the driving management device 100 transmits the manual driving information acquired from the driving operation device 200 to the traveling control device 500 as the driving information. On the other hand, when the vehicle 1 is driven by remote driving by the remote driving device 600, the driving management device 100 transmits, as the driving information, the remote driving information acquired from the remote driving device 600 to the traveling control device 500.

The driving management device 100 is a computer including a memory 110 and a processor 120. Typically, the driving management device 100 is one of electronic control units (ECUs) provided in the vehicle 1. The memory 110 stores various data 111 and a program 112 that can be executed by the processor 120. The information acquired by the driving management device 100 is stored in the memory 110 as the data 111. The processor 120 is coupled with the memory 110, reads the data 111 and the program 112 from the memory 110, and executes a process in accordance with the program 112 based on the data 111.

The process executed by the processor 120 includes a detection process of detecting the obstructive article or the guarantee article in the vehicle 1 as the process of managing handover to manual driving, and a determination process of determining whether handover to manual driving is allowed or disallowed upon receipt of the request for handover to manual driving. The detection process and the determination process will be described later.

In the driving handover system 10 according to the first embodiment, a suitable configuration and process may be adopted for handover from manual driving to remote driving. Further, the driving management device 100 may be a system composed of a plurality of computers each including a memory and a processor. In this case, the processors related to the computers cooperate with each other to execute the process of managing handover to manual driving.

The traveling control device 500 is a device that executes a process related to traveling control (typically, acceleration, braking, and steering) of the vehicle 1 in accordance with the driving information. The traveling control device 500 executes the traveling control of the vehicle 1 in accordance with the driving information, whereby manual driving or remote driving of the vehicle 1 is realized.

The traveling control device 500 is composed of, for example, multiple ECUs corresponding to respective actuators provided in the vehicle 1 or each group of the actuators. Examples of the actuators provided in the vehicle 1 include an actuator for driving a power device, an actuator for driving a brake mechanism, an actuator for driving a steering mechanism, and the like.

### 2-2. Second Embodiment

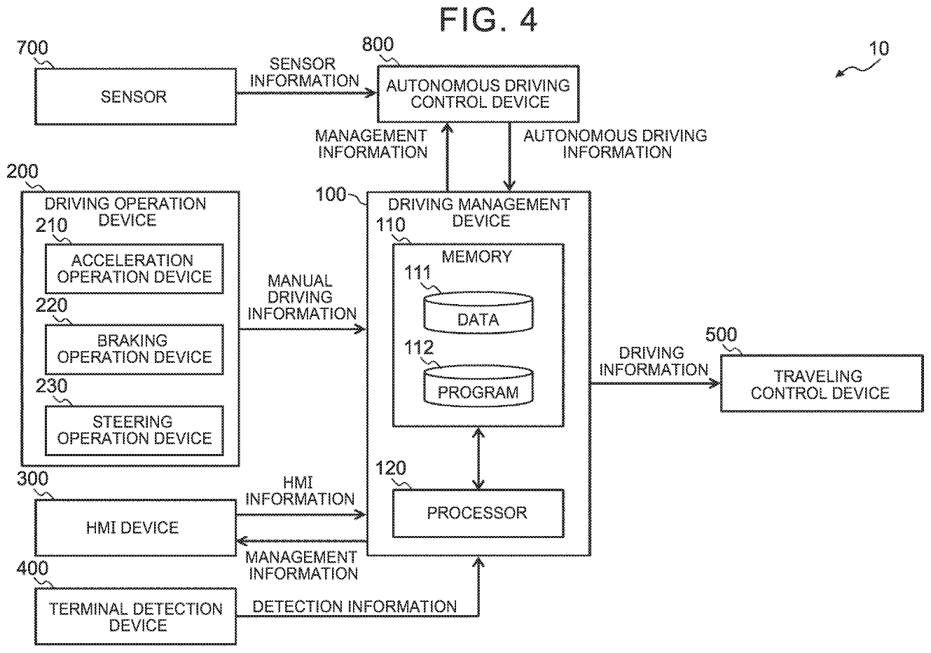

FIG. 4 is a block diagram for illustrating a schematic configuration of the driving handover system 10 according to the second embodiment. In the following, differences from the configuration according to the first embodiment will be described, and the elements overlapping with the configuration according to the first embodiment will be omitted as appropriate.

The driving handover system 10 according to the second embodiment includes the driving management device 100, the driving operation device 200, the HMI device 300, the terminal detection device 400, a traveling control device 500, a sensor 700, and an autonomous driving control device 800.

The driving operation device 200, the HMI device 300, and the terminal detection device 400 are equivalent to the configurations described in the first embodiment.

The sensor 700 detects information related to a driving environment of the vehicle 1 and outputs detected information (sensor information). The sensor 700 typically includes a sensor that detects a traveling state of the vehicle 1 (vehicle speed, acceleration, yaw rate, etc.) and a sensor that detects information on an environment around the vehicle 1 (preceding vehicle, lanes, obstacles, etc.).

Examples of the sensor that detects the traveling state of the vehicle 1 include, for example, a wheel speed sensor that detects the vehicle speed of the vehicle 1, an acceleration sensor that detects the acceleration of the vehicle 1, a gyro sensor that detects an angular velocity of the vehicle 1, and the like. Further, examples of the sensor that detects the environment around the vehicle 1 include, for example, a sensor camera, light detection and ranging (LiDAR), a millimeter wave radar, and the like.

The sensor information output by the sensor 700 is transmitted to the autonomous driving control device 800. The sensor information output by the sensor 700 may include, in addition to information that is directly detected, information acquired by arithmetic processing based on the directly detected information. In this case, the arithmetic processing may be executed in each sensor, or the sensor 700 may include a device that executes the arithmetic processing.

The autonomous driving control device 800 executes a process related to autonomous driving of the vehicle 1 based on the acquired information, and outputs information related to autonomous driving (autonomous driving information). The autonomous driving information includes, for example, a control signal related to autonomous driving. The autonomous driving control device 800 is typically one of the ECUs provided in the vehicle 1. However, the autonomous driving control device 800 may be a computer provided outside the vehicle 1. For example, the autonomous driving control device 800 may be a server configured on a communication network (typically, the Internet) with which the vehicle 1 can communicate. In this case, the autonomous driving control device 800 acquires information and outputs the autonomous driving information through communication.

The information acquired by the autonomous driving control device 800 includes, in addition to the detection information acquired from the sensor 700, the HMI information acquired from the HMI device 300 (for example, destination setting information, setting of the inter-vehicle distance, etc.), and communication information (for example, map information, road traffic information, etc.) acquired from the communication device (not shown in FIG. 4).

The autonomous driving control device 800 is configured to execute a process related to autonomous driving when autonomous driving is allowed based on the management information acquired from the driving management device 100.

The driving management device 100 has the same configuration as described in the first embodiment. However, in the second embodiment, the driving management device 100 determines whether manual driving by the driving operation device 200 and autonomous driving by the autonomous driving control device 800 are allowed, and manages driving of the vehicle 1. Further, in the driving management device 100, a process of managing handover from autonomous driving to manual driving is executed.

Therefore, the driving management device 100 transmits, as the management information, information on whether manual driving by the driving operation device 200 and autonomous driving by the autonomous driving control device 800 are allowed to the HMI device 300 and the autonomous driving control device 800. When the vehicle 1 is driven by autonomous driving by the autonomous driving control device 800, the driving management device 100 transmits the autonomous driving information acquired from the autonomous driving control device 800 to the traveling control device 500 as the driving information.

In the driving handover system 10 according to the second embodiment, a suitable configuration and process may be adopted for handover from manual driving to autonomous driving.

The traveling control device 500 may have an equivalent configuration as described in the first embodiment. The traveling control device 500 executes the traveling control of the vehicle 1 in accordance with the driving information, whereby manual driving or autonomous driving of the vehicle 1 is realized.

### 3. Driving Handover Method

Hereinafter, a process executed by the processor 120 as a process of managing handover to manual driving, and further, a driving handover method for managing handover from remote driving or autonomous driving to manual driving that is realized by the driving handover system 10 according to the present embodiment will be described.

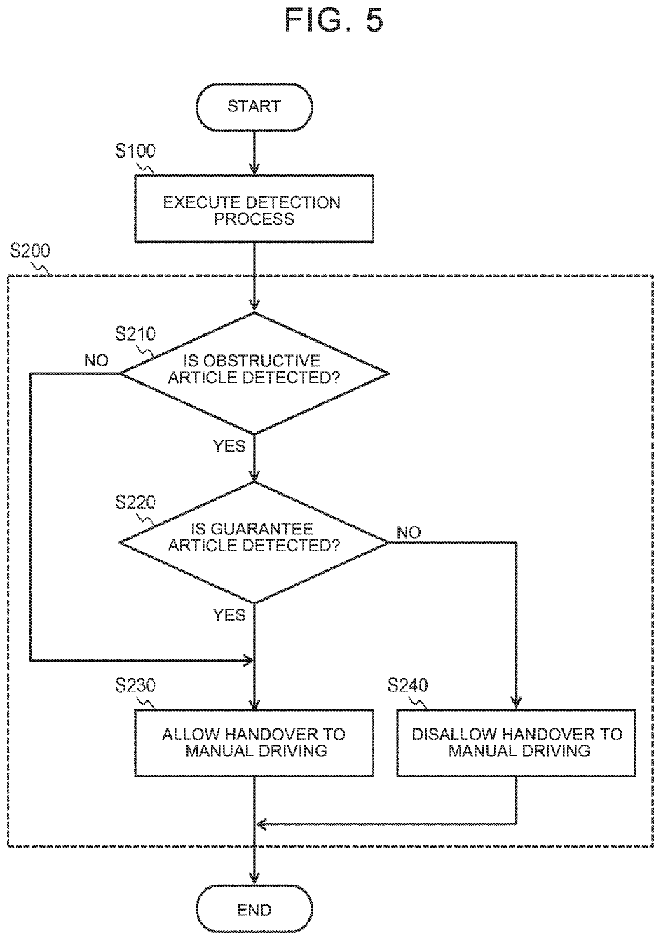

FIG. 5 is a flowchart showing processes executed by the processor 120 as the process of managing handover to manual driving. The processes shown in FIG. 5 start when the request for handover to manual driving is received, and each process is executed at predetermined intervals. Here, whether there is the request for handover to manual driving is determined, for example, based on that the operation amount of the driving operation acquired as the manual driving information is equal to or more than a predetermined value. Alternatively, whether there is the request for handover to manual driving is determined based on information on the request for handover to manual driving acquired as the HMI information.

In step S100 (detection process), the processor 120 detects the obstructive article or the guarantee article in the vehicle 1. This is performed, for example, by storing information (specific information) for specifying the obstructive article and the guarantee article in the memory 110 as the data 111, and collating the detection information acquired from the terminal detection device 400 with the specific information. Alternatively, the processor 120 may detect the obstructive article or the guarantee article by acquiring information on whether the obstructive article or the guarantee article is detected as the detection information from the terminal detection device 400.

After step S100, the process proceeds to step S200 (determination process). Here, step S200 (determination process) includes steps S210 to S240.

When the obstructive article is not detected in step S100 (step S210: No), or when the obstructive article is detected and the guaranteed article is also detected (step S210: Yes, and step S220: Yes), the process proceeds to step S230. When the obstructive article is detected and the guaranteed article is not detected in step S100 (step S210: Yes, and step S220: No), the process proceeds to step S240.

In step S230, the processor 120 allows handover to manual driving. After step S230, the process ends.

In step S240, the processor 120 disallows handover to manual driving. After step S240, the process ends.

Note that, the processor 120 may be configured to execute a process of determining permission for handover to further another manual driving in step S230. In this case, whether handover to manual driving is finally allowed is determined based on the result of the process in step S230.

Further, the processor 120 may be configured to execute the detection process at predetermined intervals all the time regardless of whether there is the request for handover to manual driving. In this case, when the request for handover to manual driving is received, the processor 120 executes the processes after step S210 shown in FIG. 5.

### 4. Effect

As described above, according to the driving handover system 10 and the driving handover method according to the present embodiments, detection of the obstructive article makes it possible to avoid inappropriate handover to manual driving by a person who is not capable of driving.

Further, when the driver is on board the vehicle 1, etc., detection of the guarantee article makes it possible to suppress that handover to manual driving is unnecessarily disallowed.

What is claimed is:

1. A driving handover system that manages handover from remote driving or autonomous driving to manual driving of a vehicle, the driving handover system comprising:
at least one memory in which a program is stored; and
at least one processor coupled with the at least one memory, wherein:
through execution of the program, the at least one processor is configured to execute
a detection process of detecting an obstructive article that causes an obstruction of the handover to the manual driving when the obstructive article is present in the vehicle, and
a determination process of determining whether the handover to the manual driving is allowed or disallowed upon receipt of a request for the handover to the manual driving; and
the at least one processor is configured to, in the determination process, disallow the handover to the manual driving when the obstructive article is detected in the detection process.

2. The driving handover system according to claim 1, wherein:
the obstructive article is a specific mobile terminal that is communicable via a communication line; and
the at least one processor is configured to detect, in the detection process, the obstructive article through communication with the mobile terminal in the vehicle.

3. The driving handover system according to claim 1, wherein the at least one processor is configured to, in the detection process, detect a guarantee article that guarantees the handover to the manual driving when the guarantee article is present in the vehicle, and
in the determination process, not to disallow the handover to the manual driving when the guarantee article is detected even in a case where the obstructive article is detected in the detection process.

4. A driving handover method for managing handover from remote driving or autonomous driving to manual driving of a vehicle, the driving handover method comprising:
a detection process of detecting an obstructive article that causes an obstruction of the handover to the manual driving when the obstructive article is present in the vehicle; and
a determination process of determining whether the handover to the manual driving is allowed or disallowed upon receipt of a request for the handover to the manual driving, wherein the determination process includes disallowing the handover to the manual driving when the obstructive article is detected in the detection process.

5. The driving handover method according to claim 4, wherein:
the obstructive article is a specific mobile terminal that is communicable via a communication line; and
the detection process includes detecting the obstructive article through communication with the mobile terminal in the vehicle.

6. The driving handover method according to claim 4, wherein:
the detection process includes detecting a guarantee article that guarantees the handover to the manual driving when the guarantee article is present in the vehicle; and
the determination process includes not disallowing the handover to the manual driving when the guarantee article is detected even in a case where the obstructive article is detected in the detection process.
